(19) United States
(12) Patent Application Publication
(10) Pub. No.: US 2014/0143164 A1
(43) Pub. Date: May 22, 2014

(54) TECHNIQUES FOR QUANTIFYING THE JOB-SEEKING PROPENSITY OF MEMBERS OF A SOCIAL NETWORK SERVICE

(71) Applicants: Christian Posse, Forster City, CA (US); Mario Rodriguez, Mountain View, CA (US); Neha Khotari, Mountain View, CA (US)

(72) Inventors: Christian Posse, Forster City, CA (US); Mario Rodriguez, Mountain View, CA (US); Neha Khotari, Mountain View, CA (US)

(21) Appl. No.: 13/682,033

(22) Filed: Nov. 20, 2012

(51) Int. Cl. G06Q 50/00

(52) U.S. Cl. CPC G06Q 50/01
USPC 705/319

(57) ABSTRACT

Techniques are described herein for deriving, for each member of a social network service, a metric representing the job-seeking propensity of the member. Additionally, techniques for classifying each member with a job-seeking status (e.g., active job-seeker, passive job-seeker, or non-job-seeker) are described. A score-generating algorithm will analyze a variety of input data—including member profile data, social graph data, and activity or behavior data—to derive a job-seeker score, representing the job-seeking propensity of a member.

### TECHNICAL FIELD

The present disclosure generally relates to data processing systems. More specifically, the present disclosure relates to methods, systems and computer program products for analyzing and processing a variety of data for the purpose of determining the job-seeking propensity of members of a social network service.

### BACKGROUND

Online or web-based social network services provide their members with a mechanism for defining, and memorializing in a digital format, their relationships with other people. This digital representation of real-world relationships is frequently referred to as a social graph. As these social network services have matured, many of the services have expanded the concept of a social graph to enable users to establish or define relationships or associations with any number of entities and/or objects in much the same way that users define relationships with other people. For instance, with some social network services and/or with some web-based applications that leverage a social graph that is maintained by a third-party social network service, users can indicate a relationship or association with a variety of real-world entities and objects (e.g., companies, schools, products and services).

In addition to hosting a vast amount of social graph data, many social network services maintain a variety of personal information about their members. For instance, with many social network services, when a user registers to become a member, the member is prompted to provide a variety of personal or biographical information, which may be displayed in a member's personal web page. Such information is commonly referred to as member profile information, or simply “profile information,” and when shown collectively, it is commonly referred to as a member's profile. For instance, with some of the many social network services in use today, the personal information that is commonly requested and displayed as part of a member's profile includes a person's age or birthdate, gender, interests, contact information, residential address (e.g., home town and/or state), the name of the person's spouse and/or family members, and so forth. With certain social network services, such as some business or professional network services, a member's personal information may include information commonly included in a professional resume or curriculum vitae, such as information about a person's education, the company at which a person is employed, an industry in which a person is employed, a job title or function, an employment history, skills possessed by a person, professional organizations of which a person is a member, and so on.

### DESCRIPTION OF THE DRAWINGS

Some embodiments are illustrated by way of example and not limitation in the FIG's. of the accompanying drawings, in which:

FIG. 1A is a diagram illustrating an example of how a single metric, referred to herein as a job-seeker score and representing a measure of a member's job-seeking propensity, is used to classify each member into one of three job-seeker classifications, consistent with some embodiments of the invention;

FIG. 1B is a table illustrating an example of how a number of members have been classified in different job-seeker classifications, based on a categorical distribution, consistent with some embodiments of the invention;

FIG. 2 is a block diagram showing the functional components of a social network service, including a job-seeker score-generating module for use in determining the job-seeking propensity of members, consistent with some embodiments of the invention;

FIG. 3 is a block diagram of some of the functional modules of a social network service and showing the flow that occurs during a method for computing or otherwise deriving job-seeker scores for the members of a social network service, consistent with some embodiments of the present invention;

FIG. 4 is a flow diagram showing the method operations of a method for determining the job-seeking propensity of a member of a social network service, consistent with some embodiments of the invention; and

FIG. 5 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products for analyzing and processing data for the purpose of determining the job-seeking propensity of members of a social network service. Once the job-seeking propensity of a member is determined, a metric representing the member's job-seeking propensity is made available to a wide variety of applications and services, thereby enabling those applications and services to personalize a member's experience based on the member's job-seeking propensity. Although various embodiments of the inventive subject matter are illustrated and described in detail, it will be evident to one skilled in the art that the present invention may be practiced without all of the specific details set forth herein.

Consistent with embodiments of the invention, a computer-based social network service includes a data processing module, referred to herein as a score-generating module, that uses a variety of input data (e.g., member profile data, social graph data, and member-activity or behavioral data) to determine the job-seeking propensity of members of the social network service. In general, the job-seeking propensity of a member is the extent to which a member is open, willing or likely to consider changing from his or her current position of employment (e.g., job) to a new position, with the same or a different employer. The job-seeking propensity of a member may be represented as a single score, referred to herein as a job-seeker score, or by assigning to each member one of several job-seeker classifications to include an active job-seeker classification, a passive job-seeker classification, and a non-job-seeker classification. Regardless of what form the metric takes, it can be used in nearly countless ways to customize and personalize various aspects of a wide variety of applications and services, many of which are described herein.

Generally, the input data with which the score-generating module determines the job-seeking propensity of members can be classified as being one of three different types of data. First, the data may be what is referred to as member profile data. Member profile data is personal data associated with a specific member (e.g., a registered user) of the social network service, and is in essence a digital representation of a person's identity. Accordingly, member profile data typically consists of biographical information, including a person's name, birthdate, age, geographical location of residence, and so forth. With some social network services, member profile data may also include a variety of education and career-oriented information commonly found in a resume or curriculum vitae. For instance, member profile data may include information about the schools (high school, college, university, graduate school, technical or vocational school, etc.) that a member has attended, or from which a member has graduated. Similarly, a member may indicate the concentration(s) of his or her academic studies, including any degrees or diplomas earned. In addition to information about a member's formal education, a member may include as part of his or her member profile, information about various positions of employment (e.g., job titles) that the member has previously held or currently holds, the name of any companies at which the member was or is currently employed, industries in which the member has been, or is, employed, any special achievements or rewards that the member has obtained, and/or any skills that the member has acquired or obtained. Of course, a wide variety of other information may also be part of a member's member profile.

With some embodiments, member profile data includes not only the information that is explicitly provided by a member, but also a number of derived or computed attributes or components. For example, a member may not explicitly specify his or her tenure at his or her current position of employment, or his or her seniority level within a company or overall career. Nonetheless, based on the information that the member does provide, his or her tenure or seniority level may be inferred—that is, computed or derived from the available information. In yet another example, a member may not specify a particular industry in which the member is employed. However, using information about the company at which the member is employed, the specific industry may be inferred. Additionally, various member profile attributes may be pre-processed for the purpose of normalizing and/or standardizing certain member profile attributes, thereby enabling more meaningful analysis and comparisons to be performed. For example, a member-provided profile attribute specifying a member's job title in free text form may be standardized by mapping the member-provided job title to a corresponding standardized job title, based on various other factors, such as the industry of the company at which the member is employed. In many instances, the same or a similar job title may be used in different industries, such that the actual skills and responsibilities of two members are very different, despite those members having the same job title (e.g., consider the title, “analyst,” in the financial services industry, and information technology industry.) By standardizing the job titles of the members, more meaningful analysis and comparisons can be achieved.

With some embodiments, various computed or derived profile attributes may be automatically made part of a member's member profile with or without the member's explicit acknowledgment. In some instances, one or more attributes or components of a member's profile may not be viewable by the member and/or any other members. For instance, while many member-provided profile attributes or components may be viewable by the public, or persons within the member's social network, depending upon the particular access privileges or settings established by the member, in some instances, various attributes or components of a member's profile may not be viewable by others. For instance, a derived member profile attribute indicating a member's seniority level may not be viewable by the member or any other members. Similarly, a metric derived to represent the job-seeking propensity of the member may be made part of the member's member profile, but may or may not be viewable by the member or any other members.

Consistent with some embodiments, one of the ways in which the data processing module determines the job-seeking propensity of a particular member is by comparing certain member profile attributes of the particular member with the aggregated member profile attributes of others. For example, some of the member profile attributes that may be used in an algorithm or algorithms for determining the job-seeking propensity of a member of a social network service are: the industry in which the member is employed, the member's seniority level, the member's tenure at his or her current position, the gender of the member, information indicating whether or not the member pays for a subscription to a particular service (e.g., a job-seeker service) provided by the social network service or some third-party service provider, and the proximity in time to a particular anniversary date of a member's starting date for his or her currently held position (e.g., 12^{th}/24^{th}/36^{th}/48^{th} month anniversaries). Any one or more of these member profile attributes may be used to perform a comparison against other member profiles with similar attributes, where the other member profiles provide historical information about the length of time, on average, that members with certain member profile attributes stay in a particular position of employment, or job.

Accordingly, with some embodiments, member profile data may be analyzed in the aggregate to determine the average (or some other measure of central tendency) length of time that members having certain sets of member profile attributes tend to stay in a particular job or employment position. This analysis may be performed using one or more machine learning algorithms. The information that results from performing the machine learning algorithm(s) can then be used to derive a measure of the job-seeking propensity of a member of the social network service.

By way of example, consider a situation in which a particular member's profile indicates that the member is a recent graduate of State University, with a B.S. degree in economics, and is currently employed at an investment bank in the financial services industry with the job title, financial analyst. By analyzing the member profile attributes of similarly situated members (e.g., members sharing certain profile attributes in common, such as members with similar seniority levels, in the same or a similar industry and with the same or a similar job title), the score-generating module may determine that similarly situated members have a tendency to change jobs on their two year anniversary date—that is, two years from the date on which they first began their job as a financial analyst. Continuing with the example, the score-generating module for deriving the metric that represents the particular member's job-seeking propensity may increase the job-seeker score for the particular member as that member's two year anniversary approaches, thereby indicating that the member's job-seeking propensity increases as the member approaches his or her two year anniversary with his current employer. Accordingly, at some point in time prior to the member's two-year anniversary of employment, the member's job-seeker classification status may go from non-job-seeker or passive job-seeker, to active job-seeker.

Another type of data that is available to the data processing module for use as input data and from which the data processing module can determine the job-seeking propensity of a member is referred to generally as social graph data. Generally, social graph data is data identifying or otherwise indicating the relationships and associations that the member has with other members, and other entities (e.g., companies, schools, etc.) represented in the social graph. For example, consistent with some embodiments, a social graph is implemented with a specialized graph data structure in which various entities (e.g., people, companies, schools, government institutions, non-profits, and other organizations) are represented as nodes connected by edges, where the edges have different types representing the various associations and/or relationships between the different entities. Although other techniques may be used, with some embodiments the social graph data structure is implemented with a special type of database known as a graph database. Accordingly, if a member is employed at a particular company, this particular association will be reflected in the social graph. Similarly, when a member joins a particular online group hosted by the social network service, or hosted by a third-party service provider, the member's membership in the group may be reflected in the social graph data.

Analysis of social graph data may signal a member's intentions, particularly as it relates to his or her job-seeking propensity. For instance, with some embodiments, by analyzing certain social graph data, the score-generating module can identify certain signals that are highly suggestive of active job-seeking activity. For example, members who are actively seeking jobs may be more likely, to follow other members of the social network service, or establish new connections with other members in a very concentrated or shortened time span—particularly other members who are job recruiters, or who are associated with a job recruiting function. Similarly, members who are actively seeking jobs may be more likely to follow certain companies at which there are open job positions matching the member's skills, or having the same job title as currently held by the member. Members who are actively seeking jobs may be more likely to join certain online groups—particularly those groups that exist primarily to aid job seekers. Accordingly, by analyzing social graph data to identify the entities with which a member is establishing associations or connections, and the timing and frequency of the activity, the job-seeking intentions of a member may be inferred, and used in the derivation of a metric representing the member's job-seeking propensity.

Some other examples of how social graph data are used to derive a metric representing a particular member's job-seeking propensity involve analyzing the activity of other members that belong to, or are otherwise associated with, some entity with which the particular member is also associated. For instance, if the social graph information indicates that an unusually large number of employees have recently departed, this may reflect an underlying issue with the vitality of the company, and thus be reflected in the particular member's job-seeking score. In particular, if the social graph data indicates that a large number of people have recently left the company at which the particular member is employed, this will have the effect of increasing the job-seeker scores for members of the social network service who are employed at the company. Similarly, if the social graph data indicates a recent surge in the overall number of employees at a particular company, this may reflect desirability of the members to work at the company, and thus decrease the job-seeker scores of current employees of the company. With some embodiments, the activity of other members who are similarly associated with a particular entity may also have an effect on the particular member's job-seeker score. For instance, if an unusually high number of employees at a particular company are actively submitting search queries to a job-related search engine, actively communicating via the social network service with other members who are job recruiters, and/or actively submitting job applications for employment positions at other companies, these activities of other members in the particular member's social graph may have an effect on the particular member's job-seeker score.

Finally, a third type of input data that may be used by the score-generating module to determine the job-seeking propensity of a member is data referred to herein as member-activity and/or behavioral data. Member-activity and behavioral data is data obtained by monitoring and tracking the interactions that a member has with various applications, services and/or content that are provided by, or, integrated or otherwise associated with, the social network service. For example, a social network service may provide any number and variety of applications and/or services with which a member interacts. Similarly, a variety of third-party applications and services may leverage various aspects of the social network service, for example, via one or more application programming interfaces (APIs). A few examples of such applications or services include: search engine applications and services, content sharing and recommendation applications (e.g., photos, videos, music, hyperlinks, slideshow presentations, articles, etc.), job posting and job recommendation applications and services, calendar management applications and services, contact management and address book applications and services, candidate recruiting applications and services, travel and itinerary planning applications and services, and many more.

Each of these applications or services may have a variety of interfaces via which a member can interact with the application or service. For example, when a member selects various links or content on a web page, these interactions may be detected and logged, along with the time at which the interactions occurred, and various contextual information about the interactions, to include a type, category or some other classification of the subject matter to which the interactions relate. In addition to interacting via a web page, various other interactions may be detected and logged, to include interactions with an application or service via a mobile application, email and other messaging techniques.

By detecting how and when members interact with such applications and services, relevant data signals can be inferred from the data and used as input to the score-generating module that determines the job-seeking propensity of members. For example, with some embodiments, a social network service may provide or be associated with one or more job posting and job recommendation applications or services. The frequency and nature of interactions that a member has with the various content modules of the job posting and recommendation applications and services may be used to infer a member's job-seeking propensity. For example, if a member regularly performs searches against a database of available job listings, this activity can be detected, logged, and used in an algorithm for determining a member's job-seeking propensity. Similarly, if a member regularly interacts with a content module (e.g., presented via a web page, email or mobile application) associated with a job recommendation application or service, the nature and frequency of the interaction can be detected, logged and used in computing or deriving a metric representing the member's job-seeking propensity. Finally, if a member regularly replies to messages (e.g., emails) received from other members of the social network service who are job recruiters, this can be detected, logged and used in determining the member's job-seeking propensity. Interactions with other types of content and other applications and services may also be used in determining a member's job-seeking propensity.

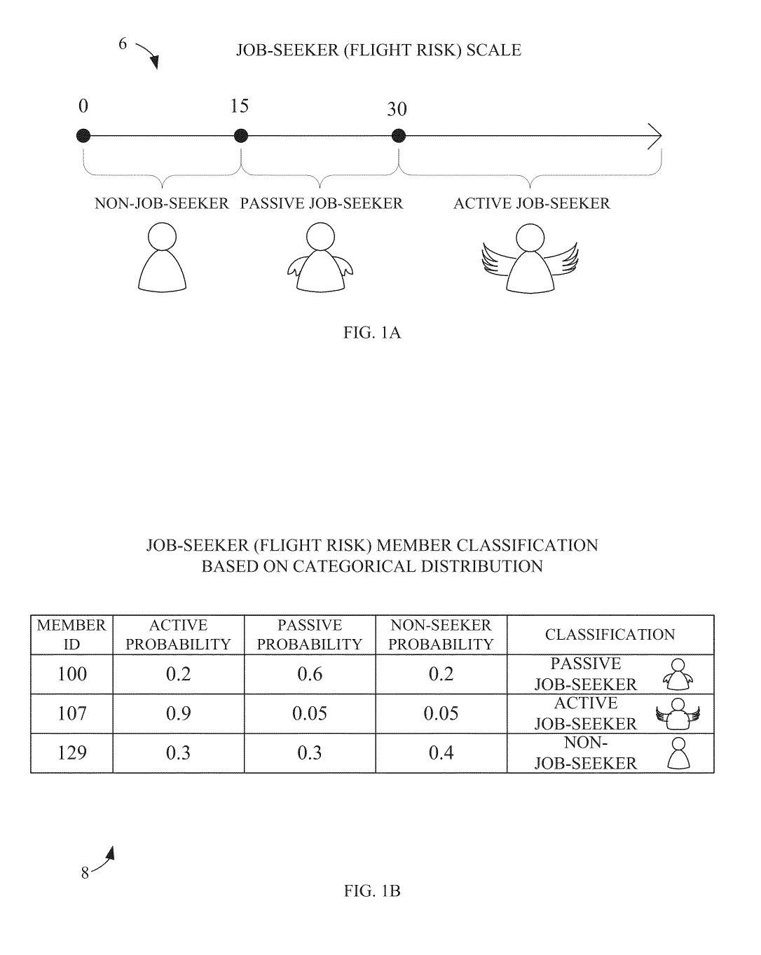

With some embodiments, the score-generating module derives or generates a single score—referred to herein as a job-seeker score—that is representative of the member's job seeking propensity. As illustrated in FIG. 1A, depending upon the particular scale 6 used in deriving the job-seeker scores for the members, which may vary from one embodiment to the next, various threshold scores may be used to classify each member as being an active job-seeker, passive job-seeker, or non-job-seeker. For example, with a job-seeker score based on a scale from zero to one-hundred, a member with a job-seeker score that falls within a first range (e.g., between zero and fifteen) may be classified as a non-job seeker. Similarly, using the same scale, a member with a job-seeker score falling in some second range (e.g., between fifteen and thirty) may be classified as a passive job-seeker, while a member with a job-seeker score falling in some third range (e.g., between thirty and one-hundred) may be classified as an active job-seeker. Of course, depending upon the specific implementation, the exact scale and thresholds may vary considerably.

With some embodiments, a categorical distribution is used to classify members as belonging to one of three job-seeker classifications, to include active job-seeker, passive job-seeker, and non-job-seeker. In probability theory and statistics, a categorical distribution is a probability distribution that describes the result of a random event (in this case, the job-seeking propensity status of a member) that can take one of K possible outcomes, with the probability of each outcome separately specified. For example, as illustrated in FIG. 1B, with some embodiments, by analyzing various input data, the score-generating module derives a categorical distribution of the probability that a member is an active job seeker, a passive job-seeker, or a non-job-seeker. In this simple example, the table with reference number 8 shows that the member of the social network service with member identifier 100 is most likely a passive job-seeker, with a probability of 0.6. Similarly, the member with member identifier 107 is classified as an active job-seeker, and the member with member identifier 129 is classified as a non-job-seeker.

With some embodiments, a member's job-seeker score and/or job-seeking classification may be computed or derived periodically (e.g., hourly, daily, weekly, etc.) and stored in association with the member's member identifier or member profile. Accordingly, applications and services can direct a request (e.g., via an application programming interface) to the social network service for the member's job seeker score by simply specifying the member identifier of the member for which the information is being requested. With some embodiments, a member's job-seeker score and/or job-seeking classification may be computed in real-time, for example, in direct response to an application requesting the information.

As described in detail below, once a metric representing a member's job-seeking propensity has been computed, the metric can be used by any number and variety of applications and services, including those that are integrated with the social network service, as well as third-party applications and services. In general, the job-seeker score and corresponding classification for a particular member can be used to personalize a member's experience, generally, and the content presented to the member specifically. For instance, with some embodiments, the specific content modules that appear in a particular user interface or web page may be selected based in part on the job-seeker score or classification of the member requesting the user interface. If, for example, the requesting member is classified as an active job-seeker, certain content modules that are more likely to be of interest to active job-seekers may be presented more prominently in a user interface or web page presented to the member. Such content modules may include job recommendations (e.g., a set of job listings that are likely to be of interest to the member) as selected by a jobs recommendation engine. In another example, when a recruiter performs a search for potential job candidates to fill an open employment position, the search results may be ranked based in part on the job-seeker scores or job-seeking classification status associated with each member profile satisfying the recruiter's search query. Consequently, the members who are classified as active job-seekers may be positioned more prominently in the search results list to reflect the higher likelihood of those members being open and responsive to a communication from the recruiter about an open employment position.

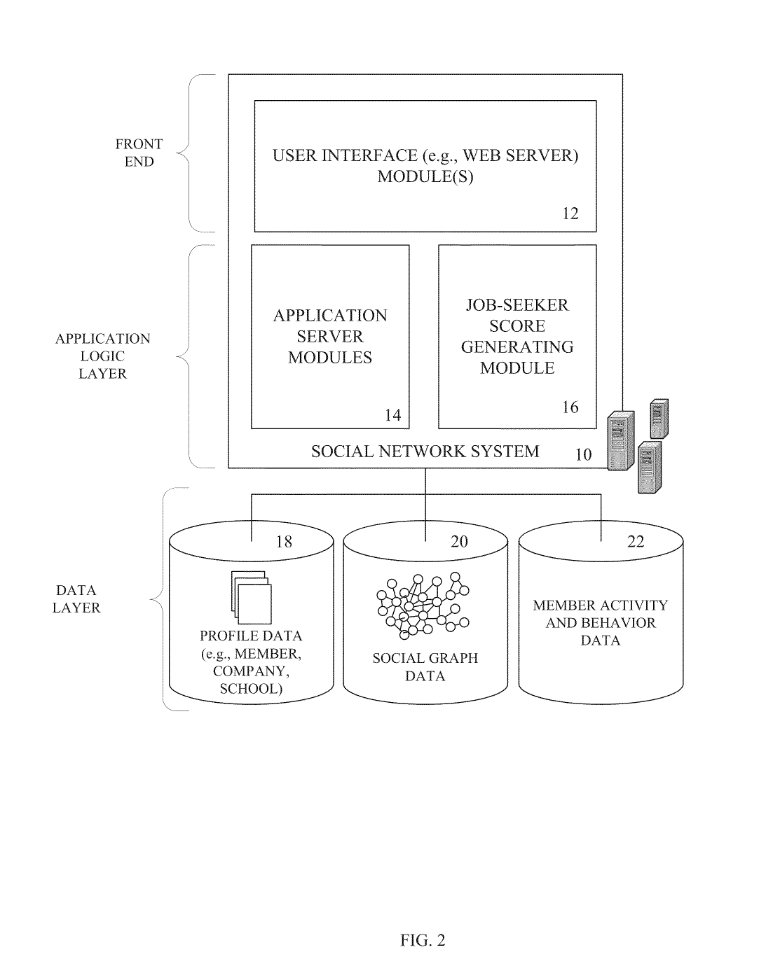

FIG. 2 is a block diagram showing the functional components of a social network service, including a data processing module referred to herein as a job-seeker score-generating module 16 (or, simply score-generating module), for use in determining the job-seeking propensity of members, consistent with some embodiments of the invention. As shown in FIG. 2, the front end consists of a user interface module (e.g., a web server) 12, which receives requests from various client-computing devices, and communicates appropriate responses to the requesting client devices. For example, the user interface module(s) 12 may receive requests in the form of Hypertext Transport Protocol (HTTP) requests, or other web-based, application programming interface (API) requests. The application logic layer includes various application server modules 14, which, in conjunction with the user interface module(s) 12, generates various user interfaces (e.g., web pages) with data retrieved from various data sources in the data layer.

With some embodiments, individual application server modules 14 are used to implement the functionality associated with various applications and/or services provided by the social network service. For example, with some embodiments, the social network service may provide an application or service that allows companies and/or people to post information about available job openings—such information generally referred to as a job posting or job listing. Accordingly, members of the social network service can search for and browse available job listings. In another example, a job recommendation engine may automatically identify a set of job listings that are likely to be of interest to a particular member. The job recommendation engine may present a member with a set of job listings that are likely to be of interest to the member. The set of job listings may be presented in a content module displayed on some portion of a web page, the user interface of a mobile device (e.g., phone or tablet computing device), or in an email or other message sent to the member on a periodic basis. As members interact with the content associated with the job listings, the interactions are detected and logged. Accordingly, the frequency and nature of the interactions can be used as input data for the score-generating module that determines the job-seeker score for the member.

As shown in FIG. 2, the data layer includes several databases, such as a database 18 for storing profile data, including both member profile data as well as profile data for various organizations (e.g., companies, schools, etc.). Consistent with some embodiments, when a person initially registers to become a member of the social network service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 18. Similarly, when a representative of an organization initially registers the organization with the social network service, the representative may be prompted to provide certain information about the organization. This information may be stored, for example, in the database with reference number 18, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within the social graph, shown in FIG. 2 with reference number 20.

The social network service may provide a broad range of other applications and services that allow members the opportunity to share and receive information, often customized or personalized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may provide a feature or service that identifies members of the social network service with which a particular member is likely to be acquainted.

As members interact with the various applications, services and content made available via the social network service, the members' behavior (e.g., content viewed, links or buttons selected, messages responded to, etc.) may be tracked and information concerning the member's activities and behavior may be logged or stored, for example, as indicated in FIG. 2 by the database with reference number 22. This information may be used to classify the member as being in various classifications or categories. For example, if the member performs frequent searches of job listings, thereby exhibiting behavior indicating that the member is a likely active job-seeker, this information can be used to classify the member as an active job-seeker. With some embodiments, this classification can then be used as a member profile attribute for purposes of enabling others to target the member for receiving messages or status updates, advertisements, or information relating to new job listings. Accordingly, a company that has available job openings can publish a message that is specifically directed to certain members of the social network service who are, based on a job-seeker score or classification, likely to be receptive to recruiting efforts.

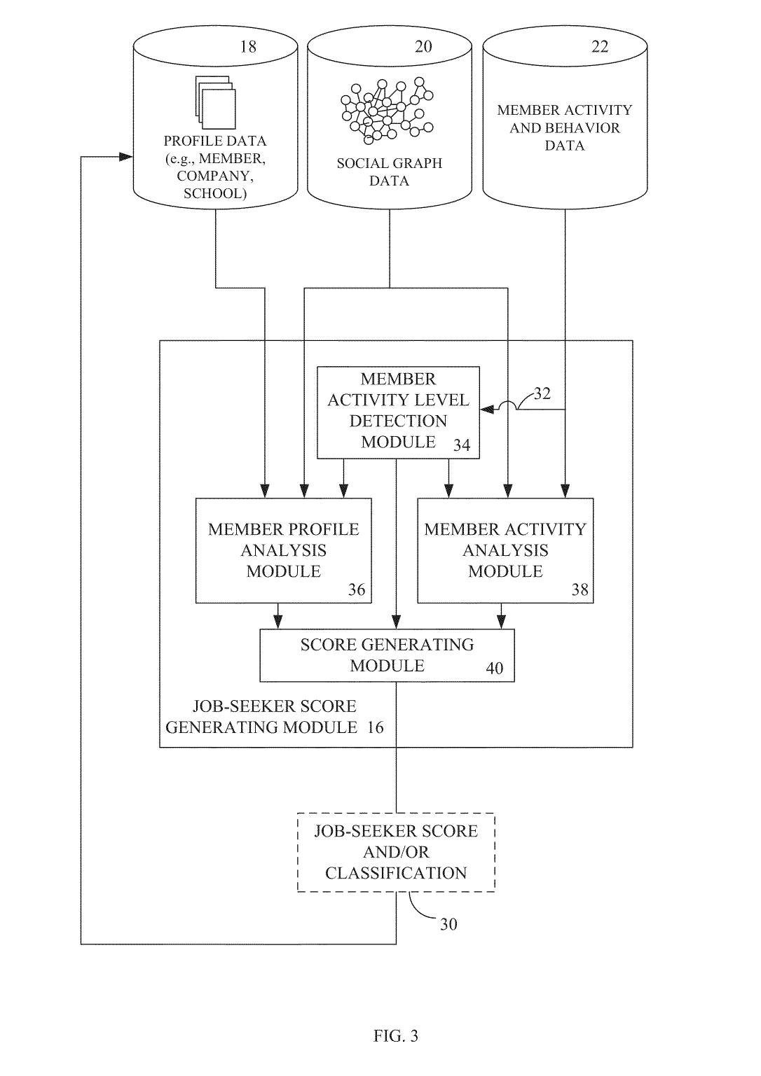

As illustrated in FIG. 2, the social network system includes what is referred to as a job-seeker score-generating module 16. The job-seeker score-generating module receives, as input, data from any one or more of the databases 18, 20 and 22, and computes or derives for each member of the social network service a metric representing the job-seeking propensity of the member. The operation of the job-seeker score-generating module is described in greater detail below in connection with the description of FIG. 3.

Although not shown, with some embodiments, the social network system 10 provides an application programming interface (API) module via which applications and services can access various data and services provided or maintained by the social network service. For example, using an API, an application may be able to request the job-seeker score and/or job-seeking classification for a particular member identified by a member identifier. Such applications may be browser-based applications, or may be operating system-specific. In particular, some applications may reside and execute on one or more mobile devices (e.g., phone, or tablet computing devices) with a mobile operating system. Furthermore, while in many cases the applications or services that leverage the API may be applications and services that are developed and maintained by the entity operating the social network service, other than data privacy concerns, nothing prevents the API from being provided to the public or to certain third-parties under special arrangements, thereby making the members' job-seeker scores and classifications available to third party applications and services.

FIG. 3 is a functional block diagram showing various functional components or modules of a job-seeker score-generating module 16, consistent with some embodiments of the invention. As illustrated in FIG. 3, with some embodiments, the job-seeker score-generating module 16 receives as input data from any one or more of three data sources, to include member profile data 18, social graph data 20, and member activity and/or behavioral data 22. For each member, the job-seeker score-generating module 16 computes or derives a job-seeker score, and/or a job-seeking classification status, such as non-job-seeker, passive job-seeker, and active job-seeker. Once computed or derived for a member, the score and/or classification is associated with the member's identifier and stored as part of the member's member profile, as indicated in FIG. 3 by reference number 30.

With some embodiments, the job-seeker score-generating module 16 may use any one of a variety of algorithms to compute or derive the job-seeker score and/or job-seeking classification for a particular member. In particular, some members may not have very much interaction with the various applications and services provided by the social network service. Consequently, for these non-active members, an algorithm that is based primarily on member profile attributes and/or social graph data, as opposed to activity and/or behavioral data, may provide a more accurate and meaningful measure of the member's job-seeking propensity. Accordingly, with some embodiments, as indicated by the line with reference number 32 in FIG. 3, a member activity level detection module 34 receives and analyzes information relating to a member's level of activity. This information may, for example, represent or identify the interactions that the particular member has had with various applications, services and content associated with the social network service. Based on a particular member's level of activity, particularly over a defined time period, the member activity level detection module 34 will select one of several possible algorithms for use in computing or deriving the job-seeker score and corresponding classification for that particular member.

If a member's activity level meets and/or exceeds some minimum threshold level, indicating that the member is regularly interacting with the various applications, services and/or content of the social network service, the member activity detection module 34 may select an algorithm that will compute or derive the member's job-seeker score and/or classification based on a combination of factors including both member profile attributes, member activity data and/or social graph data. If, however, the member's activity level does not meet or exceed some minimum threshold level, indicating that the member is in general a non-active member, the member activity detection module 34 may select an algorithm that will compute or derive the member's job-seeker score and/or classification based solely on an analysis of member profile attributes, social graph data, or some combination. Accordingly, if a member is a non-active member, the member's job-seeker score may be derived primarily based on an analysis of how similarly situated members (e.g., members with the same job title, years of experience, etc.) have behaved in the past, as evidenced in those members' member profiles. Similarly, using social graph data, the member's job seeker score may be based in part on the activity of other members connected to the particular member via the social graph. Of course, with some embodiments, the contribution of the various factors (e.g., member profile, social graph data, and activity data) may be weighted differently based on the level of activity that a member has had over a certain period of time (e.g., the previous week or month). Accordingly, different scoring algorithms may be selected, based on a member having exhibited various levels of activity, as determined by analysing member activity and behaviour data from database 22.

As illustrated in FIG. 3, with some embodiments, the member profile analysis module 36 analyzes member profile attributes of a particular member in accordance with an algorithm that has been selected by the member activity level detection module 34. The member profile analysis module 36 may extract certain member profile attributes from the member's member profile and then perform an operation to establish one or more metrics representing a member's job-seeking propensity based on analysis of the member's profile. For example, if the member's profile indicates that the member has been employed in a particular industry, with a particular job title, for a certain number of years, having a certain seniority level, and so forth, this information may be compared with aggregated information of all member profiles having the same or similar member profile attributes. Based on this analysis, a score can be derived or computed to represent the member's job-seeking propensity, based on the member's profile alone.

In addition, with some embodiments, the member profile analysis module may analyse the member profiles of other members who are connected with a particular member via the social graph, as indicated by the social graph data 20. Accordingly, the member profile analysis module 36 may detect various migration patterns of other members with whom the particular member is associated, which may have an effect on the job-seeking score. For example, if a large number of members who are connected to the particular member via the social graph and are (or, were) employed at the same company as the particular member have, as indicated in their member profiles, recently departed the company at which the particular member is currently employed, this may cause the particular member's job-seeker score to be decreased. Similarly, if a large number of members have recently joined the company at which the particular member is employed, this may decrease the particular member's job-seeker score, reflecting the overall desirability of being employed at the particular company. Of course, more fine-grained analysis can be performed as well. For instance, with some embodiments, rather than identifying an overall trend for the employee count, the analysis may be narrowed to identify a trend as it relates to a particular geographical area, business department, job title, and so forth.

With some embodiments, and depending upon the particular algorithm selected for use in computing or deriving a particular member's job-seeker score, the member activity analysis module 38 will receive and analyze information pertaining to the particular interactions that the member has had with different applications, services and content of the social network service. The member activity analysis module 38 will use the information received from database 38—information generally identifying or indicating the nature, quantity and/or timing of the member's various interactions with different applications, services and content—to compute or otherwise derive a metric representing the member's job seeking propensity, as determined based on the member's activity.

Furthermore, with some embodiments and again depending upon the particular algorithm selected, the member activity analysis module 38 may receive and analyze information pertaining to the particular interactions that other members who are connected to a particular member via the social graph have undertaken. For instance, if a statistically significant number of members closely connected via the social graph with the particular member are interacting with the social network service in various ways that are highly suggestive of job-seeking activity, this may be reflected in the job-seeker score of the particular member.

Finally, the score generating module 40 will combine the component scores (e.g., the score that is based on the member's profile, and the score that is based on the member's activity) in some manner, to derive an overall score for the member. Depending upon the member's activity level, and particular, the algorithm selected by the member activity level detection module 34, the component scores may be weighted differently such that each component score contributes appropriately to the overall job-seeker score. The score generating module may also assign a member a job-seeker classification based on the member's job-seeker score, or based on the individual probability of the member being within any one of three categories (e.g., active, passive, or non-job-seeker).

While FIG. 3 illustrates a member profile analysis module 36 and a member activity analysis module 38, in other embodiments, an independent analysis module may be provided to derive a separate sub-score based on analysis of the social graph data. Accordingly, this third sub-score would then be combined with the other sub-scores by the score generating module 40 shown in FIG. 3.

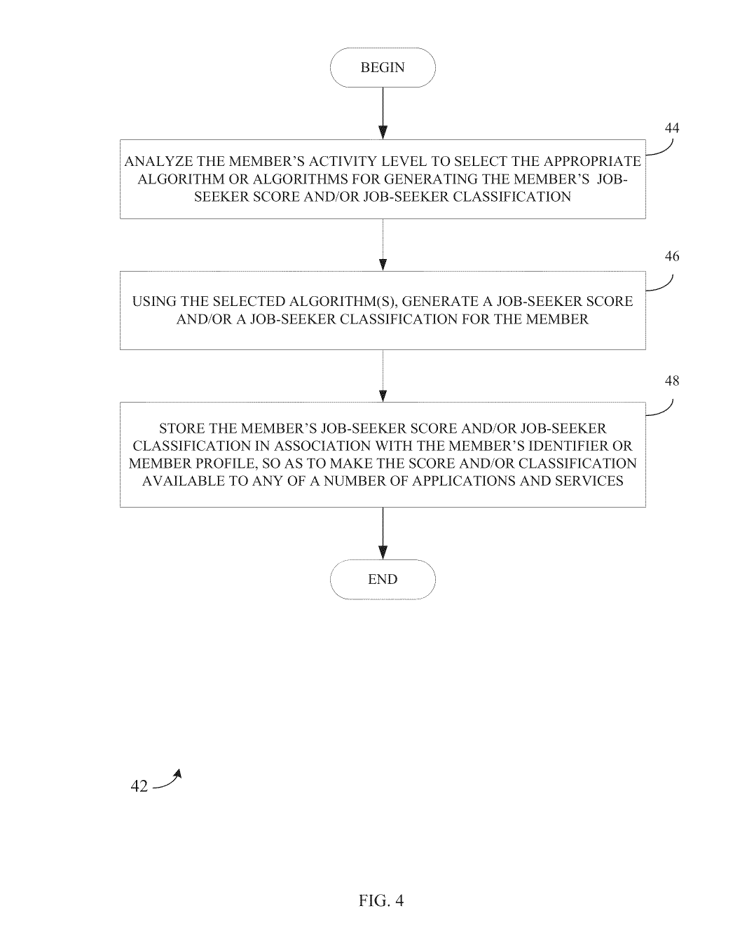

FIG. 4 is a flow diagram showing the method operations of a method 42 for determining the job-seeking propensity of a member of a social network service, consistent with some embodiments of the invention. As illustrated in FIG. 4, the method generally begins at operation 44 by analyzing a member's overall activity level to select an appropriate algorithm or algorithms for generating the member's job-seeker score and corresponding classification. If, for example, a member is an active member and frequently engages with various applications, services and content via the social network service or other applications that leverage the social network service, then an algorithm that infers a member's job seeking propensity based, in whole or in part, on the member's activity is more appropriate. However, if a member is a non-active member, an algorithm based primarily on member profile attributes may be more appropriate for determining the member's job-seeking propensity.

At method operation 46, the selected algorithm is used to compute or derive a job-seeker score for the member. Additionally, the member may be assigned a job-seeking classification, such as an active job-seeker, passive job-seeker, or non-job-seeker. The classification assigned to a particular member may be based on his or her job-seeker score falling within a certain range, or alternatively, based on a categorical distribution of the individual probabilities that a member is an active job-seeker, a passive job-seeker, or a non-job-seeker.

Finally, at method operation 48, the job-seeker score and/or the job-seeker classification are stored in association with the member's identifier and/or member profile. This allows various applications and services provided by the social network service provider to leverage an application programming interface (API), via which the job-seeker score and/or corresponding classification might be made available.

Skilled artisans will readily appreciate that any number and variety of applications and services may leverage the members' job-seeker scores and corresponding classifications to achieve a variety of objectives. As described immediately below, a few general objectives that may be achieved with job-seeker scores and corresponding classifications are 1) personalization and/or customization of a member's experience, and 2) targeting and search for members.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

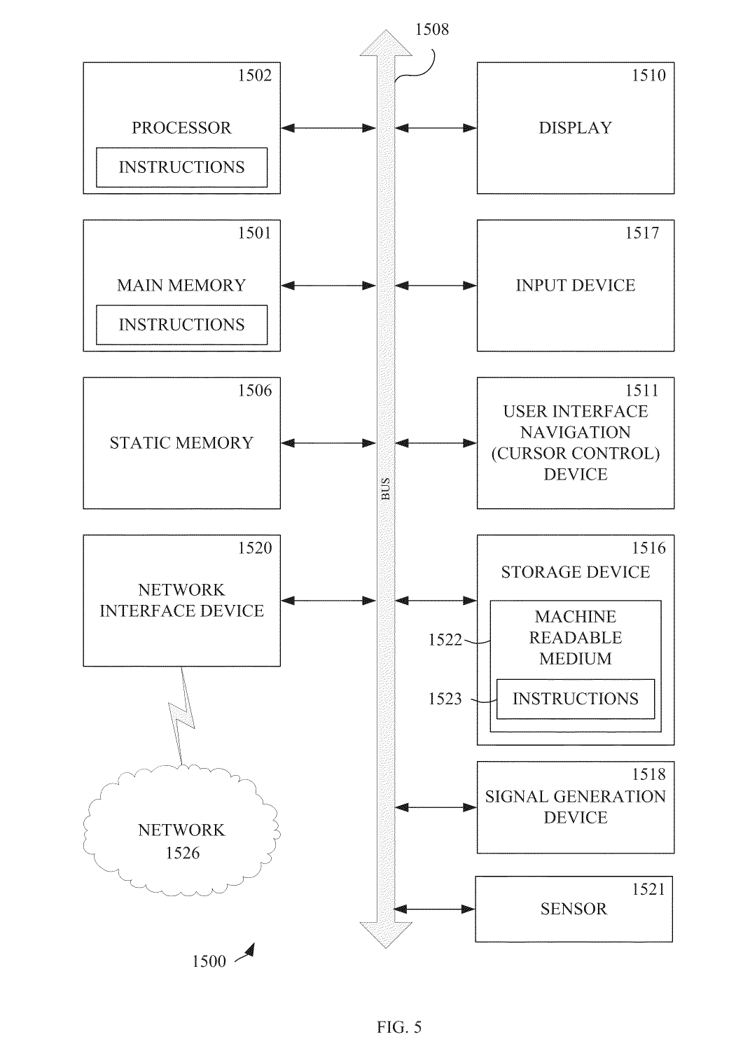

FIG. 5 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method comprising:
with a processor-based score generating module, deriving a score representing the likelihood that a member of a social network service is open to a change in employment position, the score based in part on analysis of member profile data of the member and of other members of the social network service who share, or have shared, in common one or more member profile attributes with the member of the social network service; and
storing the score in association with a member identifier of the member of the social network service so as to enable one or more applications to access the score for use in personalizing an aspect of the application for the member or another member.

2. The method of claim 1, wherein the score is derived in part by using a machine learning algorithm to analyze member profile data to determine lengths of time that members having certain sets of member profile attributes remain in particular employment positions.

3. The method of claim 1, further comprising:
based on the score derived for the member, classifying the member into one of a plurality of job-seeker classifications including an active job-seeker classification, a passive job-seeker classification, and a non-job-seeker classification.

4. The method of claim 3, further comprising:
storing the job-seeker classification of the member in association with a member identifier of the member of the social network service so as to enable one or more applications to access the job-seeker classification of the member for use in personalizing an aspect of the application for the member or another member.

5. The method of claim 1, wherein the score is based in part on any one or more of the following member profile attributes specified in the member profile of the member: an industry in which the member is employed, seniority of the member, tenure of the member at current position, gender of the member, or, proximity in time to a particular starting date anniversary.

6. The method of claim 1, wherein the score is based in part on analysis of member activity data for the member, the member activity data relating to various member interactions detected over a particular duration of time by the member with applications, services and/or content.

7. The method of claim 6, wherein the member activity data includes information specifying: the number of times the member viewed results of a job search; the number of times the member viewed results of a job recommendation engine; the number of job applications submitted for job listings; and, the number of times the member replied to a career-opportunity-related message received from another member.

8. The method of claim 1, wherein the score is based in part on analysis of member profile data of other members of the social network service who are either directly connected with the member, or share membership or association with an entity in common with the member, as indicated in a social graph maintained by the social network service.

9. The method of claim 1, wherein the score is based in part on analysis of member activity data of other members who are directly connected with the member, or other members who share membership or association with a particular entity in common with the member, as indicated in a social graph maintained by the social network service.

10. A system configured to operate an online social network service, the system comprising:
a processor-based score generating module to i) derive a score representing the likelihood that a member of a social network service is open to a change in employment position, the score based in part on analysis of member profile data of the member and of other members of the social network service who share, or have shared, in common one or more member profile attributes with the member of the social network service, and ii) to store the score in association with a member identifier of the member of the social network service, thereby enabling one or more applications to access the score for use in personalizing an aspect of the application for the member or another member.

11. A non-transitory computer readable storage medium storing instructions thereon, which, when executed by one or more processors of one or more computers, cause the one or more computers to:
derive a score representing the likelihood that a member of a social network service is open to a change in employment position, the score based in part on analysis of member profile data of the member and of other members of the social network service who share, or have shared, in common one or more member profile attributes with the member of the social network service; and
store the score in association with a member identifier of the member of the social network service, thereby enabling one or more applications to access the score for use in personalizing an aspect of the application for the member or another member.

12. A method comprising:
with a processor-based score generating module, deriving a score representing the likelihood that a member of a social network service is open to a change in employment position, the score based in part on analysis of member activity data relating to various member interactions detected over a particular duration of time; and
storing the score in association with a member identifier of the member of the social network service so as to enable one or more applications to access the score for use in personalizing an aspect of the application for the member or another member.

13. The method of claim 12, wherein the member activity data includes information specifying: the number of times the member viewed results of a job search; the number of times the member viewed results of a job recommendation engine; the number of job applications submitted for job listings; and, the number of times the member replied to a career-opportunity-related message received from another member.

14. The method of claim 12, further comprising:
based on the score derived for the member, classifying the member into one of a plurality of job-seeker classifications including an active job-seeker classification, a passive job-seeker classification, and a non-job-seeker classification.

15. The method of claim 14, further comprising:
storing the job-seeker classification of the member in association with a member identifier of the member of the social network service so as to enable one or more applications to access the job-seeker classification of the member for use in personalizing an aspect of the application for the member or another member.

16. The method of claim 12, wherein the score is based in part on analysis of member profile data of the member and of other members of the social network service who share, or have shared, in common one or more member profile attributes with the member of the social network service, the member profile attributes including: an industry in which the member is employed, seniority of the member, tenure of the member at current position, gender of the member, or, proximity in time to a particular starting date anniversary.

17. The method of claim 16, wherein the score is derived in part by using a machine learning algorithm to analyze member profile data to determine lengths of time that members having certain sets of member profile attributes remain in particular employment positions.

18. The method of claim 12, wherein the score is based in part on analysis of member profile data of other members of the social network service who are either directly connected with the member, or share membership or association with an entity in common with the member, as indicated in a social graph maintained by the social network service.

19. The method of claim 12, wherein the score is based in part on analysis of member activity data of other members who are directly connected with the member, or other members who share membership or association with a particular entity in common with the member, as indicated in a social graph maintained by the social network service.

20. A system configured to operate an online social network service, the system comprising:
a processor-based score generating module to i) derive a score representing the likelihood that a member of a social network service is open to a change in employment position, the score based in part on analysis of member activity data relating to various member interactions detected over a particular duration of time, and ii) store the score in association with a member identifier of the member of the social network service so as to enable one or more applications to access the score for use in personalizing an aspect of the application for the member or another member.

21. A non-transitory computer readable storage medium storing instructions thereon, which, when executed by one or more processors of one or more computers, cause the one or more computers to:
derive a score representing the likelihood that a member of a social network service is open to a change in employment position, the score based in part on analysis of member activity data relating to various member interactions detected over a particular duration of time, and
store the score in association with a member identifier of the member of the social network service so as to enable one or more applications to access the score for use in personalizing an aspect of the application for the member or another member.

22. A method comprising:
with a processor-based score generating module, analyzing member activity data to determine an activity level for a member of a social network service;
based on the activity level for the member of the social network service, selecting one of a plurality of algorithms for computing a score representing the job-seeking propensity of the member;
with the selected algorithm, computing the score representing the job-seeking propensity of the member; and
storing the score in association with a member identifier of the member of the social network service so as to enable one or more applications to access the score for use in personalizing an aspect of the application for the member or another member.

23. The method of claim 22, further comprising:
determining that the activity level for the member of the social network service exceeds a threshold level; and
based on the activity level of the member exceeding a threshold level, selecting from the plurality of algorithms an algorithm that uses a combination of member profile attributes and member activity data to compute for the member the score representing the job-seeking propensity of the member.

24. The method of claim 22, wherein the score is derived in part by using a machine learning algorithm to analyze member profile data to determine lengths of time that members having certain sets of member profile attributes remain in particular employment positions.

25. The method of claim 22, wherein the score is derived in part by comparing how long the member has been at his or her current employment position with a length of time that other members having certain member profile attributes shared in common with the member have remained in employment positions.

26. The method of claim 22, further comprising
determining that the activity level for the member of the social network service does not exceed a threshold level; and
based on the activity level of the member not exceeding a threshold level, selecting from the plurality of algorithms an algorithm that uses member profile attributes of the member to compute the score representing the job-seeking propensity of the member.

27. A system configured to operate an online social network service, the system comprising:
a processor-based score generating module to i) analyze member activity data to determine an activity level for a member of a social network service, ii) select one of a plurality of algorithms for computing a score representing the job-seeking propensity of the member based on the activity level for the member of the social network service, iii) compute, with the selected algorithm, the score representing the job-seeking propensity of the member, and iv) store the score in association with a member identifier of the member of the social network service so as to enable one or more applications to access the score for use in personalizing an aspect of the application for the member or another member.

28. A non-transitory computer readable storage medium storing instructions thereon, which, when executed by one or more processors of one or more computers, cause the one or more computers to:
analyze member activity data to determine an activity level for a member of a social network service;
select one of a plurality of algorithms for computing a score representing the job-seeking propensity of the member based on the activity level for the member of the social network service;
compute, with the selected algorithm, the score representing the job-seeking propensity of the member; and
store the score in association with a member identifier of the member of the social network service so as to enable one or more applications to access the score for use in personalizing an aspect of the application for the member or another member.
